(19) United States
(12) Patent Application Publication
(10) Pub. No.: US 2023/0327753 A1
(43) Pub. Date: Oct. 12, 2023

(54) NTN DISCONTINUOUS COVERAGE AND PERIODICALLY ATTEMPT TO OBTAIN SERVICE ON HIGHER PRIORITY PLMN

(71) Applicant: MEDIATEK INC., Hsin-Chu (TW)

(72) Inventors: Yuan-Chieh Lin, Hsin-Chu (TW); Marko Niemi, Oulu (FI)

(21) Appl. No.: 18/116,783

(22) Filed: Mar. 2, 2023

Related U.S. Application Data
(60) Provisional application No. 63/324,212, filed on Mar. 28, 2022.

(51) Int. Cl. H04B 7/185; H04W 48/18

(52) U.S. Cl. CPC H04B 7/18545; H04W 48/18

(57) ABSTRACT

A method of periodically attempting to access the HPLMN or an EHPLMN with higher priority in NTN systems with discontinuous coverage is proposed. A UE registered in VPLMN starts a timer T to periodically attempt to obtain service on its HPLMN or EHPLMN. When access stratum is deactivated due to discontinuous coverage in NTN, the UE does not stop the timer T, and postpone the periodic attempts to a later time, e.g., upon or after the UE activates the access stratum.

### CROSS REFERENCE TO RELATED APPLICATIONS

This application claims priority under 35 U.S.C. §119 from U.S. Provisional Application Number 63/324,212, entitled “IOT NTN PLMN Priority Inversion when considering DC (Discontinuous Coverage)”, filed on Mar. 28, 2022; U.S. Provisional Application Number 63/326,328, entitled “IOT NTN PLMN Priority Inversion when considering DC (Discontinuous Coverage)”, filed on Apr. 1, 2022, the subject matter of which is incorporated herein by reference.

### TECHNICAL FIELD

The disclosed embodiments relate generally to wireless communication, and, more particularly, to method of performing network selection in IoT NTN systems with discontinuous coverage.

### BACKGROUND

Internet of Tings (IoT) and Machine Type Communications (MTC) applications are experiencing an exponential surge and are expected to play a key role in future networks and systems. However, the industry is well aware that terrestrial networks alone will not be able to serve the key requirement of the IoT of a truly ubiquitous coverage. To fulfill with this requirement, several initiatives are currently addressing the inclusion of a satellite component into the telecommunication infrastructure to extend its coverage to those areas that are currently not served or underserved by the terrestrial networks. One of the key initiatives in this field is the 3GPP study item on NB-IOT over Non-Terrestrial Networks 3GPPstudy item on NB-IoT over Non-Terrestrial Networks (NTN). The basic idea of NTN is to deliver 5G/NR service via space (satellite) or air (airborne platform). NTN complements terrestrial networks with network coverage in remote areas over sea and land where terrestrial coverage is absent.

However, the challenge of discontinuous coverage is identified in IoT NTN systems. Discontinuous coverage in NTN is experienced in the temporal domain rather than the spatial domain, i.e., global coverage can be obtained with a single satellite, but in an intermittent matter. During the rollout of satellite constellations service will necessarily be discontinuous coverage due to the limited number of satellites in orbit. If a UE/MS uses a RAN that provides discontinuous coverage, then the UE/MS is in coverage intermittently. If the UE/MS knows how the RAN coverage varies with time based on information (e.g. from the ephemeris data of a satellite access system that the UE/MS is using), then the UE/MS may deactivate its Access Stratum functions in order to optimize power consumption until coverage returns.

For automatic and manual network selection, if the UE/MS is in a VPLMN and not registered for disaster roaming services, the UE/MS shall periodically attempt to obtain service on its HPLMN (if the EHPLMN list is not present or is empty) or one of its EHPLMNs (if the EHPLMN list is present) or a higher priority PLMN/access technology combinations listed in “user controlled PLMN selector” or “operator controlled PLMN selector” in accordance with certain requirements as defined in the Automatic Network Selection Mode. The UE/MS may start a timer T for the periodic attempt to obtain service in a HPLMN/EHPLMN with higher priority.

When access stratum of a UE is de-activated due to discontinuous coverage in NTN, the UE behaviour of periodically attempting to access the HPLMN or an EHPLMN with higher priority needs to be redefined.

### SUMMARY

A method of periodically attempting to access the HPLMN or an EHPLMN with higher priority in NTN systems with discontinuous coverage is proposed. A UE registered in VPLMN starts a timer T to periodically attempt to obtain service on its HPLMN or EHPLMN. When access stratum is deactivated due to discontinuous coverage in NTN, the UE does not stop the timer T, and postpone the periodic attempts to a later time, e.g., upon or after the UE activates the access stratum.

In one embodiment, a UE registers to a first network in a Non-Terrestrial Networks (NTN) system with discontinuous coverage, wherein the UE is in an automatic network selection mode. The UE starts a timer T at time t1 for attempting to obtain service from a second network with a higher priority than the first network, wherein the timer T is set to expire at time t3. The UE determines that the UE is out of coverage at time t2 that is before time t3, and in response the UE deactivates access stratum functions for power saving at time t2. The UE triggers an attempt to obtain service from the second network at a subsequent time t4 that is later than time t3, and wherein the access stratum functions remain deactivated at time t3. Later on, the UE is back in coverage and activates the access stratum functions, wherein the UE attempts to obtain service from the second network upon or after the UE activates the access stratum functions.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary IoT Non-Terrestrial Networks (NTN) system with discontinuous coverage and UE behaviour of attempting to access the HPLMN or an EHPLMN with higher priority in accordance with one novel aspect.

FIG. 2 illustrates simplified block diagrams of a user equipment (UE) and a network entity in accordance with embodiments of the current invention.

FIG. 3 illustrates a sequence flow between a UE and a VPLMN and a HPLMN/EHPLMN for automatic network selection mode in NTN, wherein the UE deactivate the access stratum due to discontinuous coverage, and wherein the UE postpone the attempt to obtain service on higher priority PLMN in accordance with one novel aspect.

FIG. 4 illustrates different embodiments of UE postponing the attempt to obtain service on higher priority PLMN due to discontinuous coverage in NTN.

FIG. 5 is a flow chart of a method of postponing the attempt to obtain service on higher priority PLMN due to discontinuous coverage in NTN in accordance with one novel aspect of the present invention.

### DETAILED DESCRIPTION

Reference will now be made in detail to some embodiments of the invention, examples of which are illustrated in the accompanying drawings.

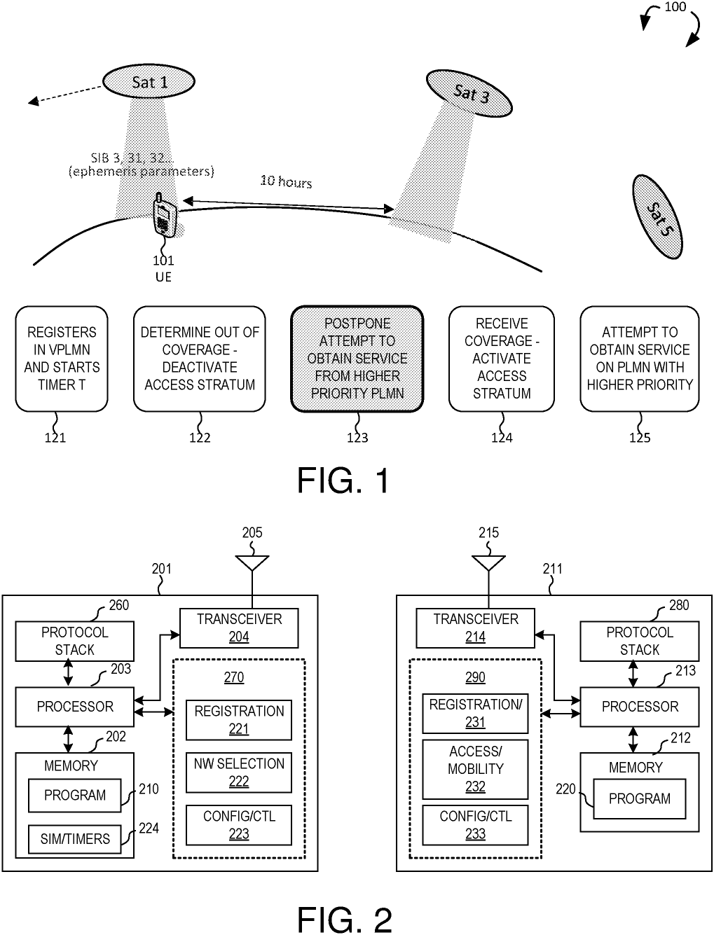

FIG. 1 illustrates an exemplary IoT Non-Terrestrial Networks (NTN) system 100 with discontinuous coverage and UE behaviour of attempting to access the HPLMN or an EHPLMN with higher priority in accordance with one novel aspect. The IoT NTN system 100 comprises a user equipment or a mobile station UE/MS 101, a first Satellite Sat1, a second satellite Sat2, and a third Satellite Sat3. UE 101 may be equipped with a radio frequency (RF) transceiver or multiple RF transceivers for different application services via different RATs/CNs. UE/MS 101 may be a smart phone, a wearable device, an Internet of Things (IoT) device, and a tablet, etc. The challenge of discontinuous coverage is identified in IoT NTN systems. Discontinuous coverage in NTN is experienced in the temporal domain rather than the spatial domain, i.e., global coverage can be obtained with a single satellite, but in an intermittent matter. During the rollout of satellite constellations service will necessarily be discontinuous coverage due to the limited number of satellites in orbit. In general, the discontinuous coverage is defined as the deployment option for satellite E-UTRAN access, in which shorter periods of satellite E-UTRAN access radio coverage are followed by longer periods of satellite E-UTRAN access coverage gaps. During coverage gaps, the access stratum may be deactivated.

In the example of FIG. 1, UE 101 is in coverage for 20 minutes every 10 hours, based on the MME/AMF knowing that the Tracking Area is associated with the discontinuous coverage in IoT NTN systems. UE 101 is in coverage intermittently, e.g., UE 101 is using satellite access with a known maximum interval (of 10 hours) between coverage occasions (of 20 minutes). If a UE uses a RAN that provides discontinuous coverage, then the UE is in coverage intermittently. If the UE knows how the RAN coverage varies with time based on information (e.g. from the ephemeris data of a satellite access system that the UE is using), then the UE may deactivate its Access Stratum functions in order to optimize power consumption until coverage returns. Tracking Area or RAT specific MME/AMF configuration can be used to support UEs using a RAN that provides discontinuous coverage (e.g. for satellite access with discontinuous coverage). For example, if a satellite system only provides coverage to a UE for 20 minutes when a satellite passes, and the maximum time before a satellite passes any point on the earth is 10 hours, the MME/AMF can configure the periodic TAU timer and mobile reachable timer to be just greater than 20 minutes and the Implicit Detach timer to be greater than 10 hours.

For automatic and manual network selection, if the UE is in a visiting PLMN (VPLMN) and not registered for disaster roaming services, the UE shall periodically attempt to obtain service on its Home PLMN (HPLMN) (if the Equivalent HPLMN (EHPLMN) list is not present or is empty) or one of its Equivalent HPLMNs (EHPLMNs) (if the EHPLMN list is present) or a higher priority PLMN/access technology combinations listed in “user controlled PLMN selector” or “operator controlled PLMN selector” in accordance with certain requirements as defined in the Automatic Network Selection Mode. The UE may start a timer T for the periodic attempt to obtain service in a HPLMN/EHPLMN with higher priority.

However, when the timer T expires in VPLMN, the UE may be out of coverage and/or has access stratum functions deactivated for power saving. As a result, the UE cannot attempt to search and obtain service on higher priority PLMN. In accordance with one novel aspect, a method of periodically attempting to access the HPLMN or an EHPLMN with higher priority in NTN systems with discontinuous coverage is proposed. As depicted in FIG. 1, UE 101 is registered in the VPLMN and starts a timer T for the purpose of periodically searching for higher priority PLMNs (121). UE 101 then determines that it is out of coverage and in response deactivates the access stratum functions for power saving (122). When the original timer T expires, UE 101 postpone the attempt to obtain service from a higher priority PLMN (123). When UE 101 is in coverage again, it activates the access stratum functions (124). Upon or after the UE activating the access stratum functions, UE 101 then triggers the attempt to obtain service from PLMN with higher priority (125).

FIG. 2 illustrates simplified block diagrams of wireless devices, e.g., a UE 201 and a network entity 211 in accordance with embodiments of the current invention. Network entity 211 may be a base station and/or an AMF/SMF/MME/SGSN/RAN. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211.

In the example of FIG. 2, network entity 211 also includes protocol stack 280 and a set of control functional modules and circuit 290. Registration and session management and handling circuit 231 handles registration, PDU/PDN/PDP establishment and modification procedures, and session management. Access and mobility management circuit 232 control the access and mobility for UE via network selection process. Configuration and control circuit 233 provides different parameters including ephemeris data (e.g., broadcasted to UE via SIB3, SIB31, and SIB32 etc.) to configure and control UE of related functionalities including mobility and session management and network selection.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of microprocessors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also comprises a set of functional modules and control circuits to carry out functional tasks of UE 201. Protocol stacks 260 comprise Non-Access-Stratum (NAS) layer to communicate with an AMF/SMF/MME/SGSN entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuits 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network.

In one example, system modules and circuits 270 comprise registration handling circuit 221 that performs registration and establishes connections with the network, a network selection circuit 222 that performs network selection based on predefined network priorities, and a config and control circuit 224 that handles configuration and control parameters for session and mobility management and network selection procedures. In one novel aspect, UE 201 is in a VPLMN and periodically attempts to obtain service on its HPLMN/EHPLMN, based on a value of timer T stored in SIM 224. When the access stratum is deactivated due to discontinuous coverage, the UE does not stop timer T. Instead, the periodic attempts may be postponed whole the UE is in power saving mode or when the access stratum is deactivated due to discontinuous coverage. Upon or after the UE re-activate the access stratum, the UE then triggers the attempts to obtain service on its HPLMN/EHPLMN having a higher priority than the VPLMN.

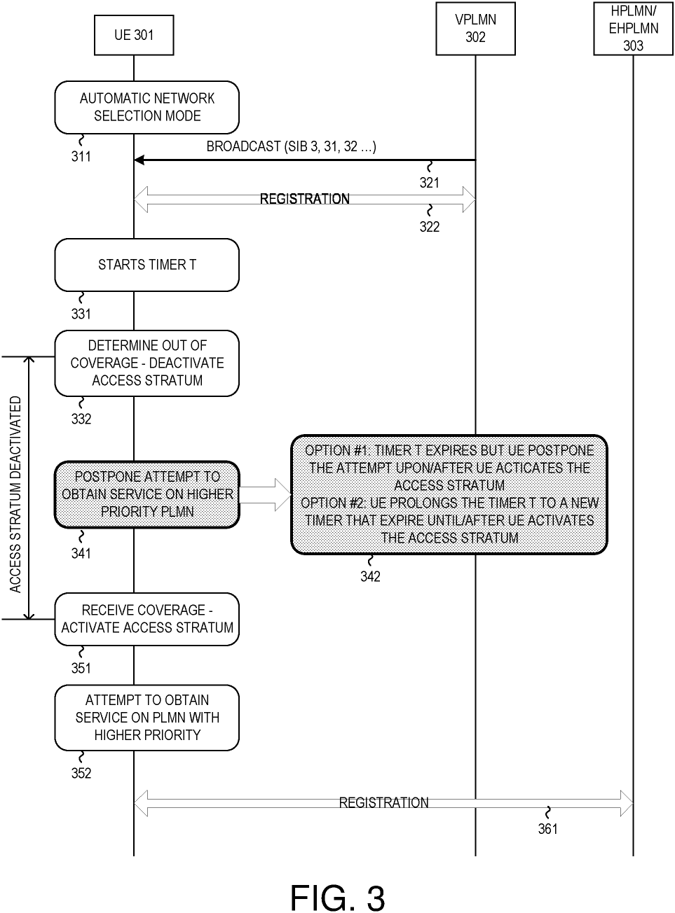

FIG. 3 illustrates a sequence flow between a UE and a VPLMN and a HPLMN/EHPLMN for automatic network selection mode in NTN, wherein the UE deactivate the access stratum due to discontinuous coverage, and wherein the UE postpone the attempt to obtain service on higher priority PLMN in accordance with one novel aspect. In step 311, UE 301 is configured with automatic network selection mode. In step 321, UE 301 receives system information blocks (SIBs) broadcasted from different PLMNs, e.g., from VPLMN 302. The broadcasted SIBs may include SIB3, SIB31, and SIB32, etc. In NTN systems with discontinuous coverage, for example, UE 301 may receive ephemeral parameters and coverage parameters in current or previously received SystemInformationBlockType32, SystemInformationBlockType31, or SystemInformationBlockType3. In step 322, UE 301 registers to the VPLMN and obtain service on the VPLMN. In step 331, UE 301 starts timer T for the purpose of periodically attempt to obtain service on its HPLMN or EHPLMN, according to the configured automatic network selection mode. In step 332, based on the ephemeral parameters, UE 301 determines that it is out of radio signal coverage. In response, UE 301 deactivates the access stratum functions to save power.

In step 341, the original timer T expires and the UE is scheduled to perform network selection for a higher priority PLMN. However, the UE also knows that the access stratum functions are deactivated due to discontinuous coverage. In one novel aspect, UE 301 postpone the attempt to obtain service on higher priority PLMN to a later time, e.g., upon or after the UE activates the access stratum. The UE can postpone the attempt by two different options (342). In Option #1, the UE keeps the original timer T running. However, when timer T expires, the UE does not triggers the attempt to obtain service on higher priority PLMN. Instead, the UE postpone the attempt to a later time, e.g., upon or after the UE activates the access stratum. In Option #2, the UE prolongs the original timer T to a new timer, which expires until/after the UE activates the access stratum. As a result, the UE can attempt to obtain service on higher priority PLMN when the new timer expires.

In step 351, UE 301 determines that it has gain the radio signal coverage and therefore it re-activates the access stratum. Accordingly, in step 352, UE 301 attempts to obtain service on a higher priority PLMN, e.g., an HPLMN or an EHPLMN. In step 361, UE 301 registers to the higher priority HPLMN/EHPLMN 303.

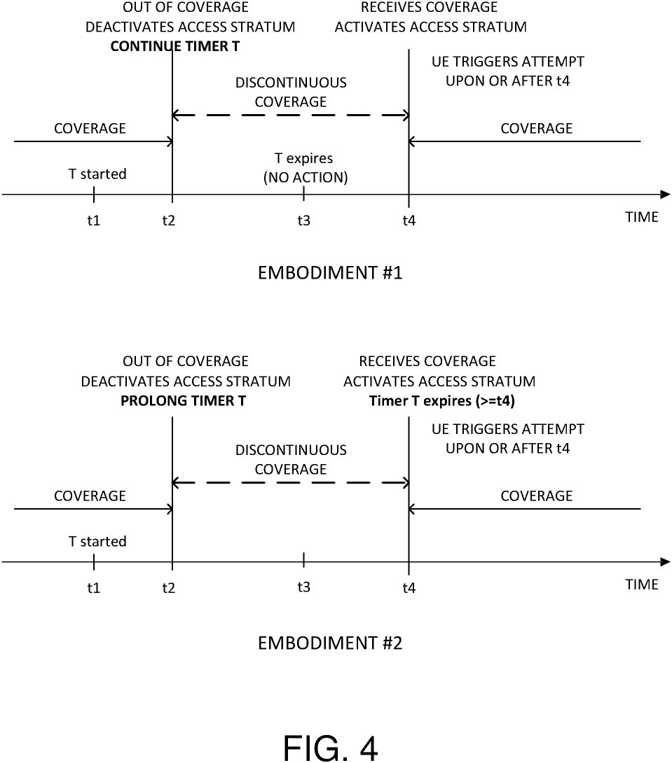

FIG. 4 illustrates different embodiments of UE postponing the attempt to obtain service on higher priority PLMN due to discontinuous coverage in NTN. In a first embodiment #1, a UE is in radio signal coverage and is registered in a VPLMN and starts timer T at time t1, for the purpose of periodically search for higher priority PLMN. Time T is configured to expire at time t3. At time t2, the UE determines that it is out of coverage due to discontinuous coverage in NTN systems. To save power, the UE enters power saving mode and deactivates the access stratum functionality. At this point, UE does not stop timer T and it keeps running. At time t3, the timer T expires. Because the UE is in power saving mode and the access stratum is deactivated, the UE postpone the attempt to obtain service on better PLMN, even though timer T is already expired. At time t4, the UE determines that it can receive radio signal and is back in coverage. The UE then activates the access stratum functionality. At time t4 or after time t4, the UE then triggers the attempt to obtain service on better PLMN (HPLMN or EHPLMN).

In a second embodiment #2, a UE is in radio signal coverage and is registered in a VPLMN and starts timer T at time t1, for the purpose of periodically search for higher priority PLMN. Time T is configured to expire at time t3. At time t2, the UE determines that it is out of coverage due to discontinuous coverage in NTN systems. To save power, the UE enters power saving mode and deactivates the access stratum functionality. At this point, the UE prolongs the original timer T to a new timer value, which expires at a later time equal or after the time t3. The UE can set the new timer value based on the ephemeris data, e.g., until or after the UE is back in coverage. At time t4, the UE determines that it can receive radio signal and is back in coverage. The UE then activates the access stratum functionality. At time t4 or after time t4, the timer expires, and the UE then triggers the attempt to obtain service on better PLMN (HPLMN or EHPLMN).

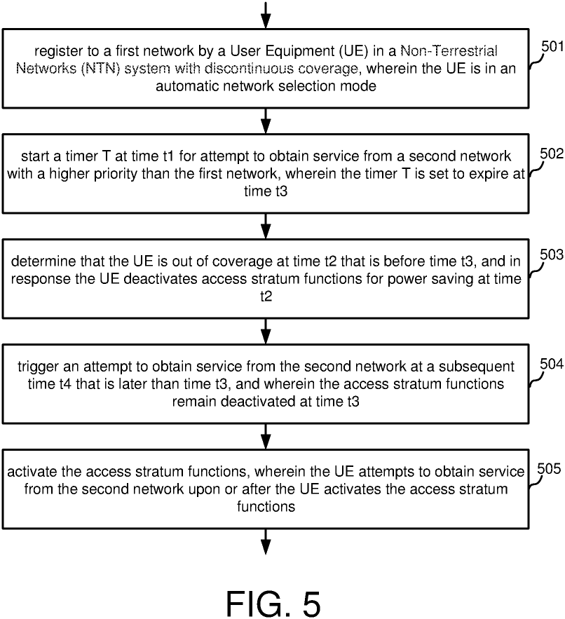

FIG. 5 is a flow chart of a method of postponing the attempt to obtain service on higher priority PLMN due to discontinuous coverage in NTN in accordance with one novel aspect of the present invention. In step 501, a UE registers to a first network in a Non-Terrestrial Networks (NTN) system with discontinuous coverage, wherein the UE is in an automatic network selection mode. In step 502, the UE starts a timer T at time t1 for attempting to obtain service from a second network with a higher priority than the first network, wherein the timer T is set to expire at time t3. In step 503, the UE determines that the UE is out of coverage at time t2 that is before time t3, and in response the UE deactivates access stratum functions for power saving at time t2. In step 504, the UE triggers an attempt to obtain service from the second network at a subsequent time t4 that is (equal or) later than time t3, and wherein the access stratum functions remain deactivated at time t3. In step 505, the UE is back in coverage and activates the access stratum functions, wherein the UE attempts to obtain service from the second network upon or after the UE activates the access stratum functions.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
registering to a first network by a User Equipment (UE) in a Non-Terrestrial Networks (NTN) system with discontinuous coverage, wherein the UE is in an automatic network selection mode;
starting a timer T at time t1 for attempting to obtain service from a second network with a higher priority than the first network, wherein the timer T is configured to expire at time t3;
determining that the UE is out of coverage at time t2 that is before time t3, and in response the UE deactivates access stratum functions for power saving at time t2; and
triggering an attempt to obtain service from the second network at a subsequent time t4 that is later than time t3, and wherein the access stratum functions remain deactivated at time t3.

2. The method of claim 1, wherein the first network is a VPLMN, and wherein the second network is a home PLMN (HPLMN) or an equivalent HPLMN (EHPLMN).

3. The method of claim 1, wherein the UE determines that the UE is out of coverage based on ephemeris data broadcasted from satellites in the NTN system.

4. The method of claim 3, wherein the ephemeris data is included in system information block (SIB) including SIB-3, SIB-31, or SIB-32.

5. The method of claim 1, wherein the UE keeps the timer T running with an original time out value and the timer T expires at time t3.

6. The method of claim 5, wherein the UE triggers the attempt to obtain service from the second network upon the UE activates the access stratum function.

7. The method of claim 5, and wherein the UE triggers the attempt to obtain service from the second network after the UE activates the access stratum functions.

8. The method of claim 1, wherein the UE prolongs the timer T to have a new time out value such that the timer T expires at the subsequent time t4, and wherein the UE triggers the attempt to obtain service from the second network upon the timer T expiry.

9. The method of claim 8, wherein the UE activates the access stratum functions at time t4.

10. The method of claim 8, wherein the UE activates the access stratum functions before time t4.

11. A User Equipment (UE), comprising:
a registration circuit that registers to a first network in a Non-Terrestrial Networks (NTN) system with discontinuous coverage, wherein the UE is in an automatic network selection mode;
a timer T that is started at time t1 for attempting to obtain service from a second network with a higher priority than the first network, wherein the timer T is set to expire at time t3;
a control circuit that determines that the UE is out of coverage at time t2 that is before time t3, and in response the UE deactivates access stratum functions for power saving at time t2; and
a network selection circuit that triggers an attempt to obtain service from the second network at a subsequent time t4 that is later than time t3, and wherein the access stratum functions remain deactivated at time t3.

12. The UE of claim 11, wherein the first network is a VPLMN, and wherein the second network is a home PLMN (HPLMN) or an equivalent HPLMN (EHPLMN).

13. The UE of claim 11, wherein the UE determines that the UE is out of coverage based on ephemeris data broadcasted from satellites in the NTN system.

14. The UE of claim 13, wherein the ephemeris data is included in system information block (SIB) including SIB-3, SIB-31, or SIB-32.

15. The UE of claim 11, wherein the UE keeps the timer T running with an original timeout value and the timer T expires at time t3.

16. The UE of claim 15, wherein the UE triggers the attempt to obtain service from the second network upon the UE activates the access stratum function.

17. The UE of claim 15, and wherein the UE triggers the attempt to obtain service from the second network after the UE activates the access stratum functions.

18. The UE of claim 11, wherein the UE prolongs the timer T to have a new timeout value such that the timer T expires at the subsequent time t4, and wherein the UE triggers the attempt to obtain service from the second network upon the timer T expiry.

19. The UE of claim 18, wherein the UE activates the access stratum functions at time t4.

20. The UE of claim 18, wherein the UE activates the access stratum functions before time t4.
